(19) United States
(12) Patent Application Publication
(10) Pub. No.: US 2009/0006328 A1
(43) Pub. Date: Jan. 1, 2009

(54) IDENTIFYING COMMONALITIES BETWEEN CONTACTS

(75) Inventors: Phillip John Lindberg, Helsinki (FI); Sami Johannes Niemela, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/770,958

(22) Filed: Jun. 29, 2007

(51) Int. Cl. G06F 3/048; G06F 7/10

(52) U.S. Cl. 707/3; 715/769; 715/810; 707/E17.14

(57) ABSTRACT

A method includes selecting a plurality of entities to be merged and aggregated, merging the selected entities and identifying at least one common feature between the selected entities, and providing a view of objects linked to the commonalities identified, wherein the objects can be selected and activated to provide more details on the selected commonality.

### BACKGROUND

1. Field

The disclosed embodiments generally relate to user interfaces and in particular to producing a set of commonalities for communication and joint action between entities.

2. Brief Description of Related Developments

Mobile devices, such as mobile communication devices, generally include a variety of applications, including for example Internet communications, instant messaging capabilities, email facilities, web browsing and searching. A user can have a large contact database with many different ways to contact more than one user. It would be advantageous to be able to identify commonalities between and among entities in a simple way and allow for quick access to such information and more detailed information.

### SUMMARY

In one aspect, the disclosed embodiments are directed to a method. In one embodiment the method includes selecting a plurality of entities to be merged and aggregated, merging the selected entities and identifying at least one common feature between the selected entities, and providing a view of objects linked to the commonalities identified, wherein the objects can be selected and activated to provide more details on the selected commonality.

In another aspect, the disclosed embodiments are directed to an apparatus. In one embodiment, the apparatus includes a controller; an input device coupled to the controller; a display coupled to the controller; and a processor coupled to the controller. In one embodiment the processor is configured to mark one or more items selected from an application; merge the marked items into a group; search the marked items for at least one area of commonality; identify the at least one area of commonality; and allow an application to be launched by selecting the at least one area of commonality, the application be related to the at least one area of commonality.

In yet another aspect, the disclosed embodiments are directed to a system. In one embodiment the system includes means for marking one or more items selected from an application; means for merging the marked items into a group; means for searching the marked items for at least one area of commonality; means for identifying the at least one area of commonality; and means for launching an application associated with the at least one area of commonality.

In yet a further aspect the disclosed embodiments are directed to a computer program product. In one embodiment, the computer program product includes a computer useable medium having computer readable code means embodied therein for causing a computer to identify attributes common to a group. In one embodiment the computer readable code means in the computer program product includes computer readable program code means for causing a computer to mark item selected from a group; computer readable program code means for causing a computer to merge the marked items into a search group; computer readable program code means for causing a computer to search each item in the group for attributes that are common to each item; computer readable program code means for causing a computer to display results of the search to a user; and computer readable program code means for causing a computer to execute an application associated with at least one of the search results when a link to a common attribute is selected.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A-2G are illustrations of exemplary screen shots of the user interface of the disclosed embodiments.

FIG. 3.is a flow chart illustrated on example of a process according to the disclosed embodiment.

FIGS. 4A-4B are illustrations of examples of devices that can be used to practice aspects of the disclosed embodiments.

FIG. 5 illustrates a block diagram of an exemplary apparatus incorporating features that may be used to practice aspects of the disclosed embodiments.

FIG. 6 is a block diagram illustrating the general architecture of the exemplary local system of FIGS. 4A-4B.

### DETAILED DESCRIPTION OF THE EMBODIMENT(s)

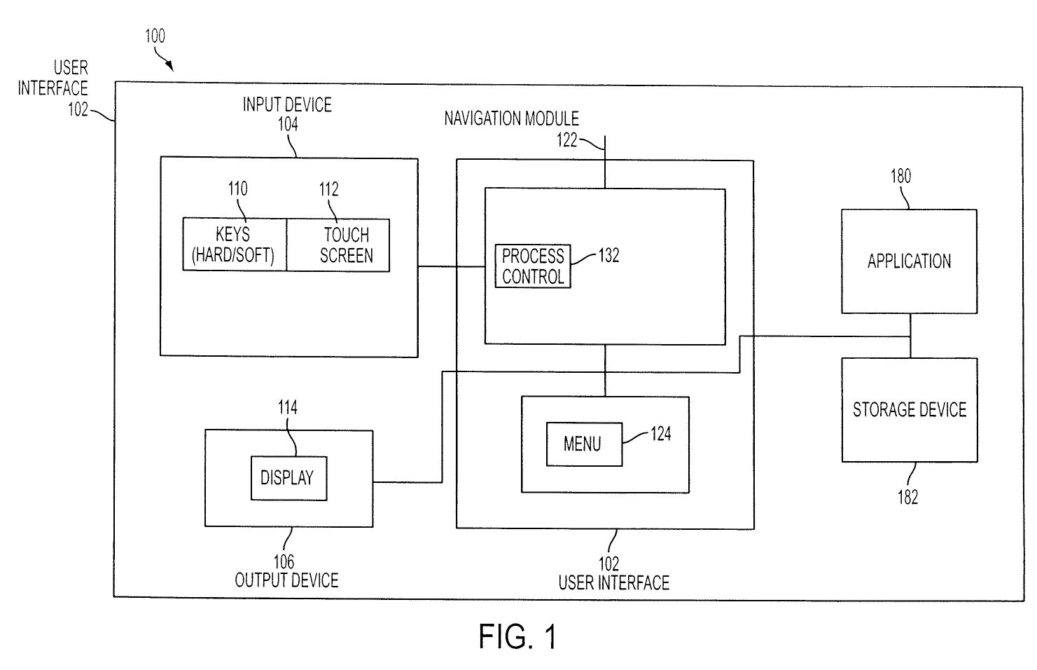

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user of a device or system, such as the system 100 shown in FIG. 1 to produce a set of commonalities from entries in a list. The entities can include for example, contacts, calendar entries, groups, messages (SMS, MMS, email, IM) and tasks. In alternate embodiments the entries can include any message or non-message related item. A user marks or selects a desired set of entities from the list. The system can then pull this set of entries and identify one or more commonalities among and between the entries. For example, if the list is a contact list, the commonalities between entities for purposes of contact and communication can be correlated. This set of commonalities can then be used as a starting point for communication and joint action, and allows the fast selection of the most appropriate channel or modality.

In one embodiment, referring to FIG. 1, the system 100 of FIG. 1 can include an input device 104, output device 106, navigation module 122, applications area 180 and storage/memory device 182. The components described herein are merely exemplary and are not intended to encompass all components that can be included in a system 100. For example, in one embodiment, the system 100 comprises a mobile communication device or other such internet and application enabled devices. Thus, in alternate embodiments, the system 100 can include other suitable devices and applications for monitoring application content and activity levels in such a device. While the input device 104 and output device 106 are shown as separate devices, in one embodiment, the input device 104 and output device 106 can be part of, and form, the user interface 102. The user interface 102 can be used to display application and contact information to the user, and allow the user to select contacts for aggregation. In one embodiment, the user interface of the disclosed embodiments can be implemented on or in a device that includes a touch screen display. In alternate embodiments, the aspects of the user interface disclosed herein can be embodied on any suitable device that will display information and allow the selection and activation of applications.

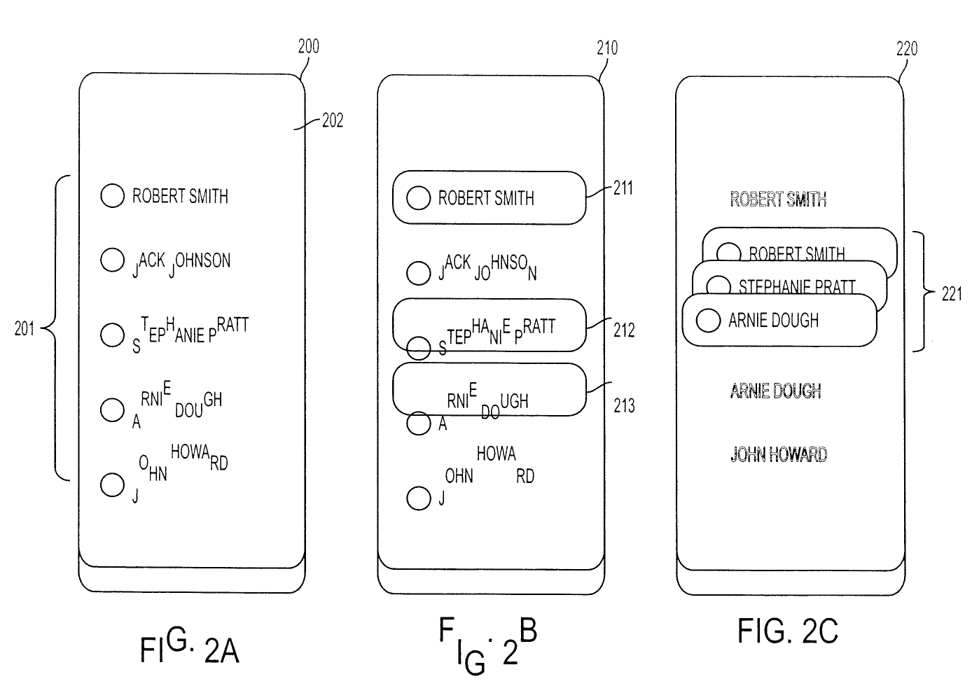

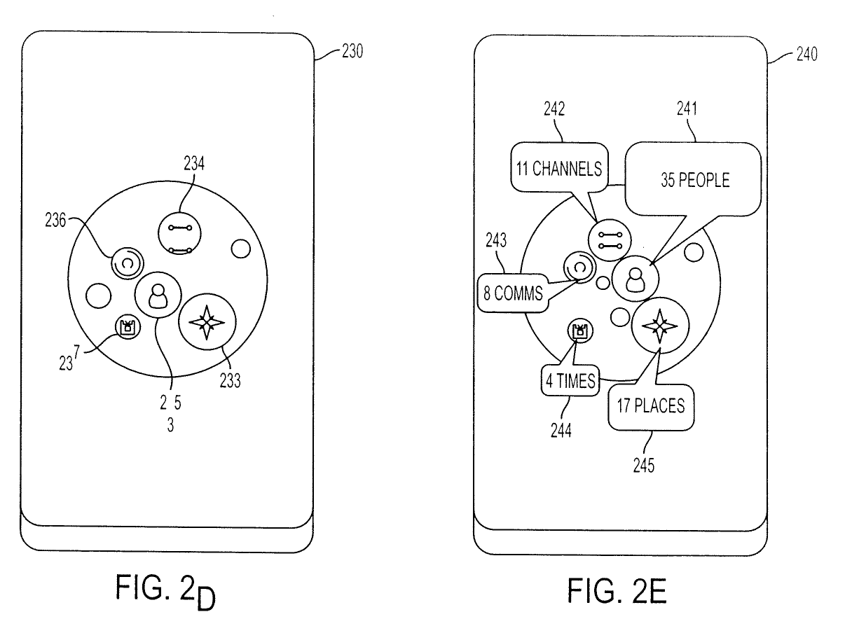

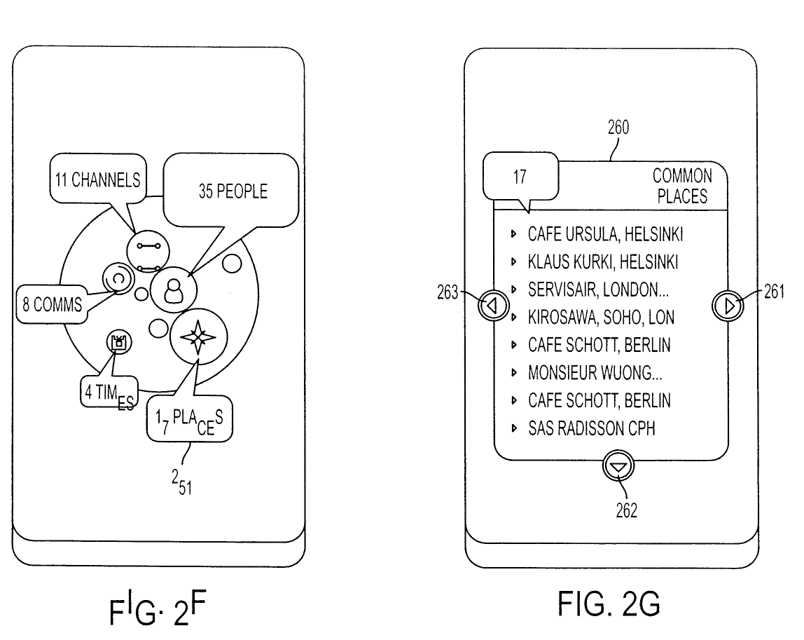

FIG. 2A illustrates one embodiment of a screen shot of a user interface 201 incorporating features of the disclosed embodiments. The example of FIG. 2A pertains to a contact application. As shown in FIG. 2A, a list 201 of entities 202 is displayed on the screen 200 of a user interface for the device 100. Although a list of entities is shown in FIG. 2A, the entities 202 can be presented to the user in any suitable manner. The user can then select the entities that are desired to be joined. In this example, three entities are chosen, entities 211, 212 and 213, as shown in FIG. 2B. The selected entities 211, 212 and 213 can be highlighted in any suitable manner on the screen 210. In one embodiment, the selected entities are dragged together to be stacked, as shown in FIG. 2C. This provides a visual presentation of the entities selected for merging.

The common aspects to each of the selected and aggregated entities are then determined and identified. In one embodiment this can comprise searching each entry for common criteria and identifying each common area. For example, areas or topics that can be searched can include for example, places, times and communications. Alternatively, an algorithm can be applied that searches people (e.g. channel preferences), time (e.g. calendar entries), and places (geotags), and compiles useful aggregations. In one embodiment, metadata, such as for example Internet Protocol metadata, associated with each of the entries is searched and compared to identify the commonalities and aggregations. Metadata can provide a series of opportunities, or commonalities, based on the aggregated contact data shown in FIG. 2C. The aggregated entities can then merge into a view of commonalities, as shown for example in FIG. 2D.

As shown in FIG. 2D, the display 230 presents the commonalities as part of a pie menu structure or circular menu structure 232. The round view of commonalities displays each common aspect or feature. In one embodiment, referred to FIG. 2E, bubbles or pop-up windows, such as window 241, can identify the commonality(s) in addition to the graphical image or icon, such as 234 of FIG. 2D. The explanations can appear by popping out right after the commonality wheel.

In one embodiment, referring to FIG. 2F, any one of the commonalities can be selected for further action. In FIG. 2F, the “Places” icon 251 is selected. Selection of “places” will provide a list of common places among the merged entities. When a particular icon is selected, it can be configured to alter at least one attribute, such as for example size, shape and color, to identify the selection. Once selected, a new view of the details of the selection can be displayed on the device, as shown for example in FIG. 2G. As shown in FIG. 2G, selection of the “places” icon 251 results in a list of places common to each of the three entities to be displayed. The navigation elements 261-263 allow the user to navigate through the various “places” views. Down 262 can close the view, while left 263 and right 261 navigates through other lists of common places.

In one embodiment, referring to FIG. 2, the commonalities can be overlaid or dragged together to filter and focus the commonalities. In one embodiment, the history of the individual can be used to filter and focus commonalities. For example, by bringing places and times together, an invitation application could be initiated that would include this time and place information. When comparing geotags on digital images or photographs, it can be determined that the photographs have a common geographical location, or place. This could be the basis for the initiation of a meeting, for example. The commonalities can be used as the basis for improved quality in communication.

In one aspect, the disclosed embodiments provide a convenient way to determine the best mode to communication with several people. With respect to the example illustrated in FIG. 2A, the user can mark each entity in a list that the user desires to have joined an electronic conversation, for example. After the user has marked or otherwise selected the relevant or desired entity, the system will determine the commonalities of the communication channels associated with and between each entity. In this example, communication channels have been specified as the commonality search criteria. The system will then display the communication-based commonalties. For example, the commonality view may show that instant messaging is the most effective means of communication with each of the desired entities. Alternatively, the commonalities view might identify that one portion of the group is available using one communication channel, while another group is available over another communication channel. In another example, the system could identify that the relevant contacts are active or on-line, and can be contacted using one or more messaging protocols. The commonalty view might group the relevant contacts according to current communication availability and communication protocol. Thus, the commonalities view does not have to be based on one set of search criteria, and can include any number of suitable criteria. In alternate embodiments, the commonalities view can provide any number of groupings based on one or more common attributes amongst the entities.

In one embodiment, the disclosed embodiments can employ a commonality search criteria. While in one aspect, all commonalities, or the most pertinent commonalities can be searched for, aggregated and presented in a commonality view, as discussed in the example above, the commonalities view can be directed to a particular subject matter, such as for example, communication channels. In other embodiments, other suitable criteria can be used, including for example common locations, similar media content, biographical data, Internet browsing habits, interests, or common entities.

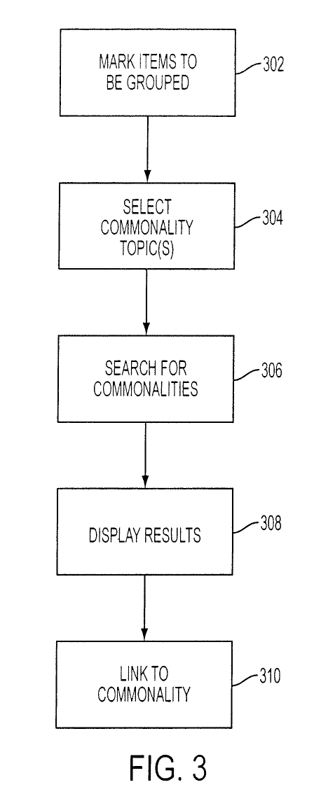

FIG. 3 is one example of a process incorporating aspects of the disclosed embodiments. One or more items are marked to be grouped 302. The items can come from a list, file or other suitable medium. In one embodiment, a commonality search criteria can be selected 304. For example, the search can comprise a global search, looking for all commonalities, or the search can be focused by a common item, topic or subject matter. The search is executed 306 to identify commonalities among the items in the group. The search results are then correlated and presented 308. This can include for example, a listing of the commonalities or displaying the commonalities as items or objects in a group. The relevance or ranking of each commonality, or an explanation of each, can also be displayed. For example, if the commonality is communication channels, the most used or common communication channel can be ranked highest. The results may also be grouped by more than one criterion. For example, the commonalities might be grouped according to communication channel and an active presence on a particular channel. In one embodiment, a link to a commonality grouping can be provided 310. For example, if a commonality grouping comprises available communication channel and active user presence, selecting the icon or object associated with this group might open a connection on the available communication channel with each user that is indicated as active. This allows for an advantageous and efficient way to communicate amongst entities.

The aspects of the disclosed embodiments can be implemented on any device that includes a user interface for the display and accessing of information, such as the system 100 shown in FIG. 1. In one embodiment, the input device 104 includes a touch screen display 112 on which the contact lists and commonality views can be displayed. The inputs and commands from a user, such as the touching of the screen, are received in the input module 104 and passed to the navigation module 122 for processing. The output device 106, which in one embodiment is implemented in the touch screen display 112, can receive data from the user interface 102, application 180 and storage device 182 for output to the user. The selection and aggregation of entities 211, 212 and 213 as disclosed herein can be processed in the navigation module 122 and the aggregation and commonality results passed to the output device 106 for display to the user, as well as for further action.

Each of the input device 104 and output device 106 are configured to receive data or signals in any format, configure the data or signals to a format compatible with the application or device 100, and then output the configured data or signals. While a display 114 is shown as part of the output device 106, in other embodiments, the output device 106 could also include other components and device that transmit or present information to a user, including for example audio devices and tactile devices.

The user input device 104 can include controls that allow the user to interact with and input information and commands to the device 100. For example, with respect to the embodiments described herein, the user interface 102 can comprise a touch screen display or a proximity screen device. The output device 106 can be configured to provide the content of the exemplary screen shots shown herein, which are presented to the user via the functionality of the display 114. Where a touch screen device is used, the displays 112 and 114 can comprise the same or parts of the same display. User inputs to the touch screen display are processed by, for example, the touch screen input control 112 of the input device 104. The input device 104 can also be configured to process new content and communications to the system 100. The navigation module 122 can provide controls and menu selections, and process commands and requests. Application and content objects can be provided by the menu control system 124. The process control system 132 can receive and interpret commands and other inputs, interface with the application module 180, storage device 180 and serve content as required. Thus, the user interface 102 of the embodiments described herein, can include aspects of the input device 104 and output device 106.

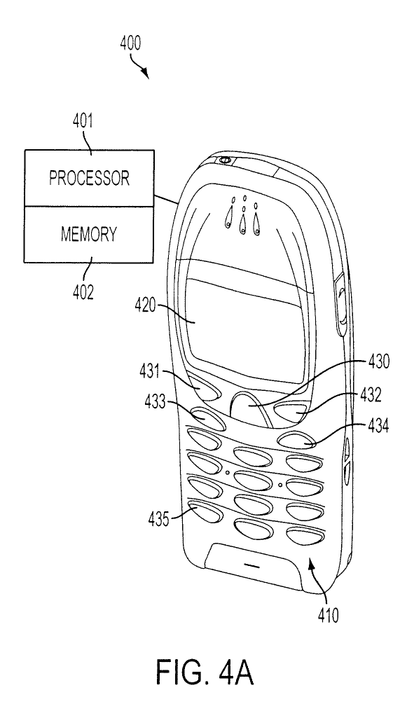

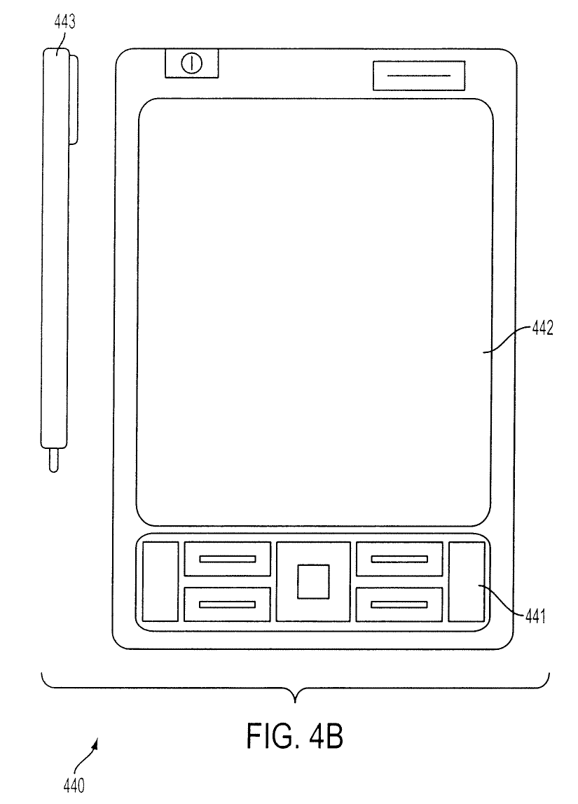

Examples of devices on which aspects of the disclosed embodiments can be practiced are illustrated with respect to FIGS. 4A and 4B. The terminal or mobile communications device 400 may have a keypad 410 and a display 420. The keypad 410 may include any suitable user input devices such as, for example, a multi-function/scroll key 430, soft keys 431, 432, a call key 433, an end call key 434 and alphanumeric keys 435. The display 420 may be any suitable display, such as for example, a touch screen display or graphical user interface. The display may be integral to the device 400 or the display may be a peripheral display connected to the device 400. A pointing device, such as for example, a stylus, pen or simply the user's finger may be used with the display 420. In alternate embodiments any suitable pointing device may be used. In other alternate embodiments, the display may be a conventional display. The device 400 may also include other suitable features such as, for example, a camera, loud speaker, connectivity port or tactile feedback features. The mobile communications device may have a processor 401 connected to the display for processing user inputs and displaying information on the display 420. A memory 402 may be connected to the processor 401 for storing any suitable information and/or applications associated with the mobile communications device 400 such as phone book entries, calendar entries, etc.

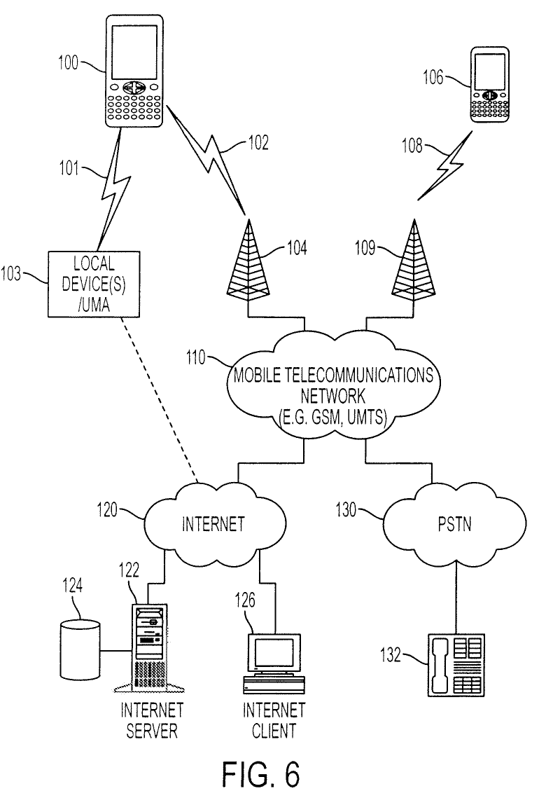

In the embodiment where the device 400 comprises a mobile communications device, the device can be adapted to communication in a telecommunication system, such as that shown in FIG. 6. In such a system, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 600 and other devices, such as another mobile terminal 606, a line telephone 632, a personal computer 651 or an internet server 622. It is to be noted that for different embodiments of the mobile terminal 600 and in different situations, some of the telecommunications services indicated above may or may not be available. The aspects of the disclosed embodiments are not limited to any particular set of services in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example GSM, UMTS, D-AMPS, CDMA2000, (W)CDMA, WLAN, FOMA and TD-SCDMA.

The mobile telecommunications network 610 may be operatively connected to a wide area network 620, which may be the internet or a part thereof. An internet server 622 has data storage 624 and is connected to the wide area network 620, as is an internet client computer 626. The server 622 may host a www/wap server capable of serving www/wap content to the mobile terminal 600.

A public switched telephone network (PSTN) 630 may be connected to the mobile telecommunications network 610 in a familiar manner. Various telephone terminals, including the stationary telephone 632, may be connected to the PSTN 630.

The mobile terminal 600 is also capable of communicating locally via a local link 601 or 651 to one or more local devices 603 or 650. The local links 601 or 651 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 603 can, for example, be various sensors that can communicate measurement values to the mobile terminal 600 over the local link 601. The above examples are not intended to be limiting, and any suitable type of link may be utilized. The local devices 603 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 600 may thus have multi-radio capability for connecting wirelessly using mobile communications network 610, WLAN or both. Communication with the mobile telecommunications network 610 may also be implemented using WiFi, WiMax, or any other suitable protocols, and such communication may utilize unlicensed portions of the radio spectrum (e.g. unlicensed mobile access (UMA)). In one embodiment, the navigation module 122 of FIG. 1 can include a communications module that is configured to interact with the system described with respect to FIG. 6.

In one embodiment, the system 100 of FIG. 1 may be for example, a PDA style device 440 illustrated in FIG. 4B. The PDA 440 may have a keypad 441, a touch screen display 442 and a pointing device 443 for use on the touch screen display 442. In still other alternate embodiments, the device may be a personal communicator, a tablet computer, a laptop or desktop computer, a television or television set top box, or any other suitable device capable of containing the display 442 and supported electronics such as a processor and memory. The exemplary embodiments herein will be described with reference to the mobile communications device 400 for exemplary purposes only and it should be understood that the embodiments could be applied equally to any suitable device incorporating a display, processor, memory and supporting software or hardware.

The user interface 102 of FIG. 1 can also include a menu system 124 in the navigation module 122. The navigation module 122 provides for the control of certain processes of the device 100. The menu system 124 can provide for the selection of different tools and application options related to the applications or programs running on the device 100. In the embodiments disclosed herein, the navigation module 122 receives certain inputs, such as for example, signals, transmissions, instructions or commands related to the functions of the device 100. Depending on the inputs, the navigation module interprets the commands and directs the process control 132 to execute the commands accordingly.

Activating a control generally includes any suitable manner of selecting or activating a function associated with the device, including touching, pressing or moving the input device. In one embodiment, where the input device 104 comprises control 110, which in one embodiment can comprise a device having a keypad, pressing a key can activate a function. Alternatively, where the control 110 of input device 104 also includes a multifunction rocker style switch, the switch can be used to select a menu item and/or select or activate a function. When the input device 104 includes control 112, which in one embodiment can comprise a touch screen pad, user contact with the touch screen will provide the necessary input. Voice commands and other touch sensitive input devices can also be used.

Although the above embodiments are described as being implemented on and with a mobile communication device, it will be understood that the disclosed embodiments can be practiced on any suitable device. For example, the device 100 of FIG. 1 can generally comprise any suitable electronic device, such as for example a personal computer, a personal digital assistant (PDA), a mobile terminal, a mobile communication terminal in the form of a cellular/mobile phone, or a multimedia device or computer. In alternate embodiments, the device 100 of FIG. 1 may be a personal communicator, a mobile phone, a tablet computer, touch pad device, Internet tablet, a laptop or desktop computer, a television or television set top box a DVD or High Definition player or any other suitable device capable of containing for example a display 114 shown in FIG. 1, and supported electronics such as the processor 401 and memory 402 of FIG. 4. For description purposes, the embodiments described herein will be with reference to a mobile communications device for exemplary purposes only and it should be understood that the embodiments could be applied equally to any suitable device incorporating a display, processor, memory and supporting software or hardware.

Referring to FIG. 1, the display 114 of the device 100 can comprise any suitable display, such as noted earlier, a touch screen display, proximity screen device or graphical user interface. In one embodiment, the display 114 can be integral to the device 100. In alternate embodiments the display may be a peripheral display connected or coupled to the device 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of an LCD with optional back lighting, such as a TFT matrix capable of displaying color images. A touch screen may be used instead of a conventional LCD display.

The device 100 may also include other suitable features such as, for example, a camera, loudspeaker, connectivity port or tactile feedback features.

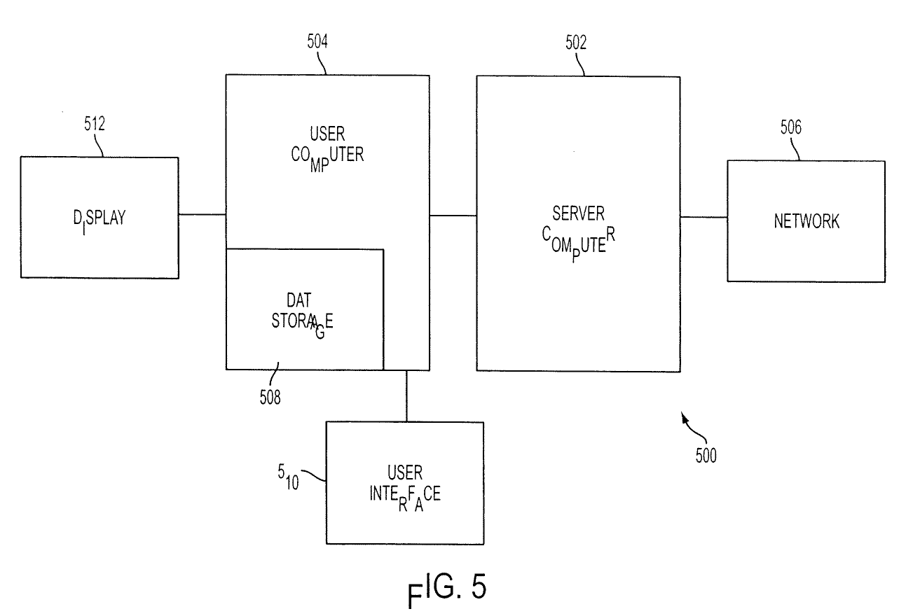

The disclosed embodiments may also include software and computer programs incorporating the process steps and instructions described above that are executed in different computers. FIG. 5 is a block diagram of one embodiment of a typical apparatus 500 incorporating features that may be used to practice aspects of the invention. The apparatus 500 can include computer readable program code means for carrying out and executing the process steps described herein. As shown, a computer system 502 may be linked to another computer system 504, such that the computers 502 and 504 are capable of sending information to each other and receiving information from each other. In one embodiment, computer system 502 could include a server computer adapted to communicate with a network 506. Computer systems 502 and 504 can be linked together in any conventional manner including, for example, a modem, wireless, hard wire connection, or fiber optic link. Generally, information can be made available to both computer systems 502 and 504 using a communication protocol typically sent over a communication channel or through a dial-up connection on ISDN line. Computers 502 and 504 are generally adapted to utilize program storage devices embodying machine-readable program source code, which is adapted to cause the computers 502 and 504 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 502 and 504 may also include a microprocessor for executing stored programs. Computer 502 may include a data storage device 508 on its program storage device for the storage of information and data. The computer program or software incorporating the processes and method steps incorporating aspects of the invention may be stored in one or more computers 502 and 504 on an otherwise conventional program storage device. In one embodiment, computers 502 and 504 may include a user interface 510, and a display interface 512 from which aspects of the invention can be accessed. The user interface 510 and the display interface 512 can be adapted to allow the input of queries and commands to the system, as well as present the results of the commands and queries.

The disclosed embodiments generally provide for a user to merge people and places into common views that identify and display the common features. The commonalities can be expanded/selected for more detailed information. Commonalities can be overlaid or dragged together to filter and focus the commonalities. For example, dragging people and places together would initiate an invitation that would include time and place information. This set of commonalities can be used as a starting point for communication and action and fast selection of the most available channel.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

What is claimed is:

1. A method comprising:
selecting a plurality of items to be merged and aggregated;
merging the selected items and identifying at least one attribute that is common to the selected items; and
displaying the at least one common attribute as a selectable object, wherein each object can be selected and activated to provide more details on at least one common attribute.

2. The method of claim 1 further comprising providing an explanation view linked to the common attribute to identify the attribute.

3. The method of claim 1 further comprising providing a link to an application associated with the common attribute, wherein selection of the link starts the application .

4. The method of claim 3 further comprising, when the common attribute is a communication channel, and activating the link establishes a communication connection over the communication channel .

5. The method of claim 3 wherein identifying at least one common attribute comprises identifying a common, active messaging system between the selected items.

6. The method of claim 5 further comprising automatically initiating a meeting request on the active messaging system between and among the selected items when the link is selected.

7. The method of claim 5 further comprising opening a communication channel on the active messaging system to an entity corresponding to the selected item.

8. The method of claim 1 wherein selecting the items to be merged further comprises simultaneously selecting the desired items and dragging the selected items into a common view.

9. The method of claim 1 further comprising defining a search criteria for identifying the at least one common feature.

10. The method of claim 9 wherein the search criteria comprise multiple search topics.

11. The method of claim 1 further comprising ranking each common attribute relative to each other common attributes in a group of common attributes.

12. An apparatus comprising:
a controller;
an input device coupled to the controller;
a display coupled to the controller; and
a processor coupled to the controller, wherein the processor is configured to:
mark one or more items selected from an application;
merge the marked items into a group;
search the marked items for at least one area of commonality;
identify the at least one area of commonality; and
allow an application to be launched by selecting the at least one area of commonality, the application be related to the at least one area of commonality.

13. The apparatus of claim 12, wherein the processor is further configured to display the at least one area of commonality as a group of commonalties, and ranking each area of commonality in the group with respect to each other.

14. The apparatus of claim 12 wherein the processor is further configured to carry out the search for the at least one area of commonality using one or more search criterion.

15. The apparatus of claim 12 wherein the processor is further configured to provide a detailed view of the at least one area of commonality when an object associated with the at least one area is selected.

16. A system comprising:
means for marking one or more items selected from an application;
means for merging the marked items into a group;
means for searching the marked items for at least one area of commonality;
means for identifying the at least one area of commonality; and
means for launching an application associated with the at least one area of commonality.

17. The system of claim 16 further comprising means for providing a detailed view of the at least one area of commonality when an object associated with the at least one area is selected.

18. A computer program product embodied in memory of a device comprising:
a computer useable medium having computer readable code means embodied therein for causing a computer to identify attributes common to a group, the computer readable code means in the computer program product comprising:
computer readable program code means for causing a computer to mark item selected from a group;
computer readable program code means for causing a computer to merge the marked items into a search group;
computer readable program code means for causing a computer to search each item in the group for attributes that are common to each item;
computer readable program code means for causing a computer to display results of the search to a user; and
computer readable program code means for causing a computer to execute an application associated with at least one of the search results when a link to a common attribute is selected.

19. The computer program product of claim 18 further comprising computer readable program code means for causing a computer to search for commonalities between each item in the marked group, wherein a search criteria includes one or more attributes.

20. The computer program product of claim 18 further comprising computer readable program code means for causing a computer to display a group of commonalities as a selectable object, wherein selection of the object causes detailed information to be displayed with respect to the group of commonalties.

21. The computer program product of claim 20 further comprising computer readable program code means for causing a computer to launch at least application corresponding to the group of commonalties when the object is selected.
